(19) United States
(12) Patent Application Publication
(10) Pub. No.: US 2017/0173980 A1
(43) Pub. Date: Jun. 22, 2017

(54) MEDIUM HANDLING

(71) Applicant: HEWLETT-PACKARD DEVELOPMENT COMPANY, L.P., Houston, TX (US)

(72) Inventors: Daniel Gonzalez Perello, Barcelona (ES); Martin Urrutia Nebreda, Barcelona (ES); Martin Ramis Llinares, Sant Cugat del Valles (ES)

(73) Assignee: HEWLETT-PACKARD DEVELOPMENT COMPANY, L.P., Houston, TX (US)

(21) Appl. No.: 15/310,185

(22) PCT Filed: May 27, 2014
(86) PCT No.: PCT/US2014/039540

§ 371 Date: Nov. 10, 2016

(51) Int. Cl. B41J 11/04; B65H 23/04; B65H 23/038; B65H 16/02; B65H 20/02

(52) U.S. Cl. CPC B41J 11/04; B65H 16/021; B65H 20/02; B65H 23/038; B65H 23/048; B65H 2801/06

(57) ABSTRACT

Medium handling apparatuses and methods of media handling, both for use in printing devices, are disclosed herein. An example of a medium handling apparatus includes a first transport roller to convey a medium and a first drive mechanism to rotate the first transport roller at a first rate. This example of the medium handling apparatus additionally includes a second transport roller to convey the medium and a second drive mechanism to rotate the second transport roller at a second rate. This example of the medium handling apparatus further includes a coupling assembly to disengage the second transport roller from the second drive mechanism to allow the medium to rotate the second transport roller at the first rate.

### BACKGROUND

End users appreciate reliability and performance in printing devices. They also appreciate quality output and cost effective solutions for their printing needs. Designers and manufacturers may, therefore, endeavor to create and provide printing devices directed toward one or more of these objectives.

### BRIEF DESCRIPTION OF THE DRAWINGS

The following detailed description references the drawings, wherein:

FIG. 1 is an example of a printing device.

FIG. 2 is an example of a medium handling apparatus.

FIG. 3 is an example of additional components of the medium handling apparatus of FIG. 2.

FIG. 4 is another example of additional components of the medium handling apparatus of FIG. 2.

FIG. 5 is an additional example of a further component of the medium handling apparatus of FIG. 2.

FIG. 6 is an alternative example of a medium handling apparatus.

FIG. 7 is an example of an additional component of the medium handling apparatus of FIG. 6.

FIG. 8 is another example of additional components of the medium handling apparatus of FIG. 6.

FIG. 9 is an additional example of a further component of the medium handling apparatus of FIG. 6.

FIG. 10 is an example of a medium handling method for use in the priming device of FIG. 1.

FIG. 11 is an example of additional elements of the media handling method of FIG. 10.

### DETAILED DESCRIPTION

Media utilized in a printing device needs to be accurately moved from an input or source location toward a printzone for printing. Media may be conveyed from the input or source by transport roller assemblies. The media may then be conveyed to the printzone by a drive roller assembly.

In order to help achieve this accurate movement, media tension needs to be controlled. Such control of tension helps to ensure accurate advancement of the media toward the drive roller assembly, as well as limiting lateral movement (i.e., skew) of the media. For example, if tension between transport roller assemblies lowers excessively or even becomes zero, then a bubble will grow between the transport roller assemblies resulting in a loss of control of the media and a jerking of the media once tension increases again. Such bubbles can cause media jams in the printing device, which need to be cleared, and/or damage to the media, both of which are undesirable.

As another example, if the tension between the transport roller assemblies rises excessively, then a slippage of the media can occur between the transport roller assemblies. This results in a loss of accurate media control which can cause degradation in output print quality of a printing device. Excessively high media tension can also damage the media by causing tears and/or marks on the media resulting from slippage of one or more of the transport roller assemblies.

One way the tension of the media can be controlled is through the use of synchronization mechanisms to ensure that all transport assembly and drive assembly rollers rotate at the same rate. This approach could be implemented through the use of gear trains and/or belts to link all the rollers. Difficulties with this approach, however, include complexity and cost associated with such gear trains and belts. Also, this approach does not compensate for diameter differences between rollers or allow for changes in speed between transport assembly rollers and drive assembly rollers.

Another approach can utilize independent driving systems for each roller with electrical and code-based synchronization between each roller. Difficulties with this approach include both added complexity and cost, as well as lost lime associated with initial set-up and routine calibration due to wear and tear of the rollers of the transport roller assembly and drive roller assembly.

Another way the tension of the media can be controlled is through the use of a dancer roller mechanism that accumulates the media in order to keep media tension constant regardless of rate variations between rollers of transport roller assembly and/or drive roller assembly. However, this approach adds expense and complexity to the design of a printing device. It also, increases the bulk and footprint size of a printing device.

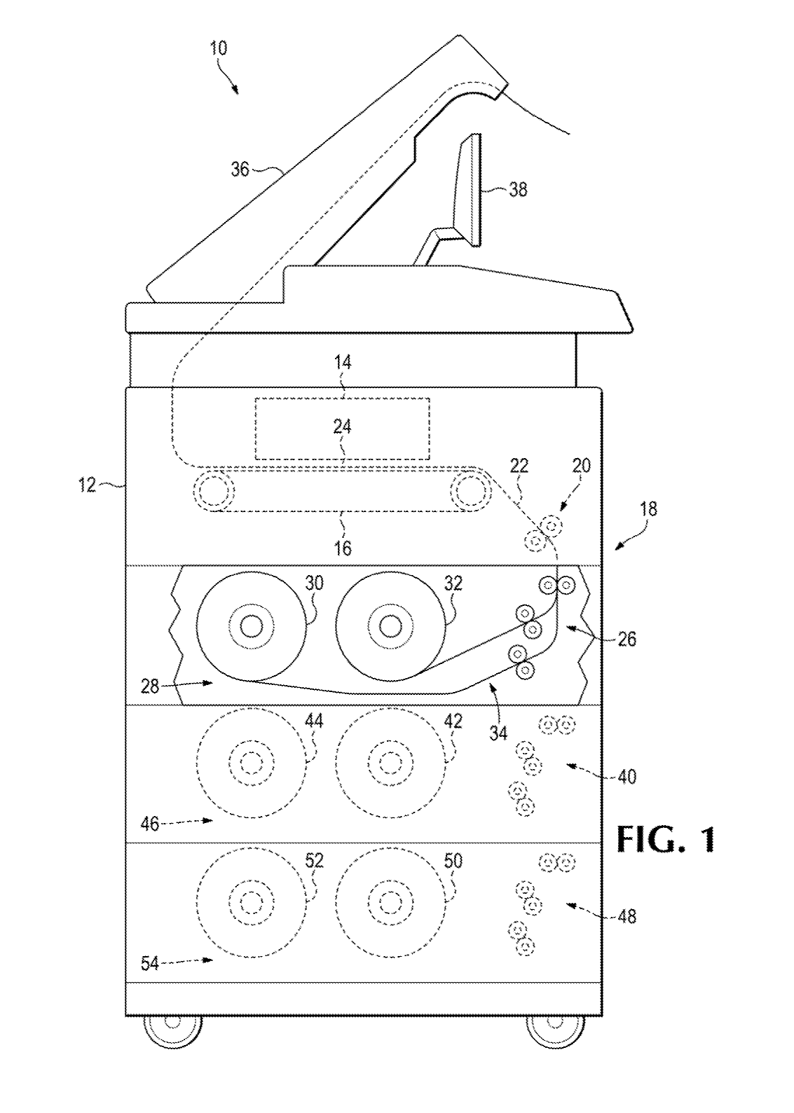

Examples directed to controlling the tension in media used in a printing device are shown in FIGS. 1-11. These examples help to address the above-described issues associated with lack of such media tension control while also providing a relatively simple, cost-effective, efficient, and compact solution.

As used herein the term “printing device” represents a printer, plotter, press and/or device that uses any of the following marking technologies or a combination thereof: ink jet, laser jet, dye sublimation, liquid toner, off-set printing, 3D, or dot matrix. As used herein the terms “media” and “medium” arc interchangeable and represent any type of paper or other printing medium (e.g., cloth, cardboard, canvas, transparency, substrate, etc.), having any type of finish on either or both sides (e.g., glossy, matte, plain, textured, etc.), in any size, shape, color, or form (e.g., sheet, roll (cut or uncut), folded, etc.) on which printing composition (e.g., ink, toner, colorant, wax, dye, powder, latex, printing fluid or solid, etc.) is placed, jetted, deposited, dropped, formed, or laid to create one or more images or items (e.g., text, graphics, pictures, formulas, charts, two-dimensional objects, three-dimensional objects, etc.).

As used herein, the term “printing mechanism” represents a mechanism or device that implements any of the above-described marking technologies. As used herein, the term “printzone” represents the area, location or portion a printing device where a printing mechanism utilizes priming composition to create one or more images and/or items on a medium.

As used herein, the term “drive mechanism” represents the motor(s), shaft(s), gear(s), control electronics and/or other structure that provide or impart motion to a device, such as a roller or roller assembly. As used herein, the term “media path” represents the guide(s), nip(s), chute(s), roller(s) and/or other structure used to advance and control the coupling of media supplies from an input location.

As used herein, the term “encoder assembly” represents any device, circuit, processor, machine readable instructions or combination thereof that converts information from one format to another. An example of an encoder assembly includes, but is not limited to, an electro-mechanical device that converts angular position and/or motion of a shaft, axle or roller to an analog or digital signal. As used herein, the term “freewheel assembly” represents a device that disengages a motor, gear or driveshaft from a driven roller, gear or shaft when the driven roller, gear or shaft rotates faster than the motor, gear or driveshaft.

As used herein, the term “processor” represents an instruction execution system such as a computer-based system, an Application Specific Integrated Circuit (ASIC), a computing device, a machine readable instruction system, or any combination thereof, that can fetch or obtain the logic from a non-transitory storage medium and execute the instructions contained thereon. “Processor” can also include any controller, state-machine, microprocessor, logic control circuitry, cloud-based utility, service or feature, any other analogue, digital and/or mechanical implementation thereof, or any combination of the forgoing.

As used herein, the term “non-transitory storage medium” represents any medium that can contain, store, retain, or maintain programs, code, scripts, information, and/or data. A non-volatile storage medium can include any one of many physical media such as, for example, electronic, magnetic, optical, electromagnetic, or semiconductor media. A non-volatile storage medium can be a component of a distributed system. More specific examples of suitable non-volatile storage media include, but are not limited to, a magnetic computer diskette such as floppy diskettes or hard drives, magnetic tape, a read-only memory (ROM), an erasable programmable read-only memory (EPROM), a Hash drive or memory, a compact disc (CD), a digital video disk (DVD), or a memristor.

An example of a printing device 10 is shown in FIG. 1. As can be seen in FIG. 1, printing device 10 includes a housing 12 in which a printing mechanism 14 and a vacuum belt assembly 16 are disposed. Printing device 10 also includes a medium handling apparatus 18 disposed in housing 12. Medium handling apparatus 18 includes a drive roller assembly 20 that conveys medium 22 to a printzone 24 defined between printing mechanism 14 and vacuum belt assembly 16. Medium handling apparatus 18 also includes a transport roller assembly 26 to convey medium 22 from medium input 28 to drive roller assembly 20. Medium handling apparatus 18 additionally includes a plurality of media supplies 30 and 32 and a media path 34 to selectively couple one of media supplies 30 and 32 to transport roller assembly 26. Media supplies 30 and 32 may be the same type of medium or different types of medium. Printing device 10 additionally includes a medium output 36 to receive printed medium from printzone 24 and a user interface 38.

As can also be seen in FIG. 1, in this example, medium handling apparatus 18 of printing device 10 additionally includes transport roller assembly 40 disposed in housing 12 to convey medium front media supplies 42 and 44 located in medium input 46 to drive roller assembly 20. Media supplies 42 and 44 may be the same type of medium or different types of medium. Medium handling apparatus 18 further includes transport roller assembly 48 disposed in housing 12 to convey medium from media supplies 50 and 52 located in medium input 54 to drive roller assembly 20. Media supplies 50 and 52 may be the same type of medium or different types of medium. Although not shown in FIG. I, it is to he understood that media handling apparatus 18 also includes a media path to selectively couple one of media supplies 42 and 44 to transport roller assembly 40 and a media path to selectively couple one of media supplies 50 and 52 to transport roller assembly 48.

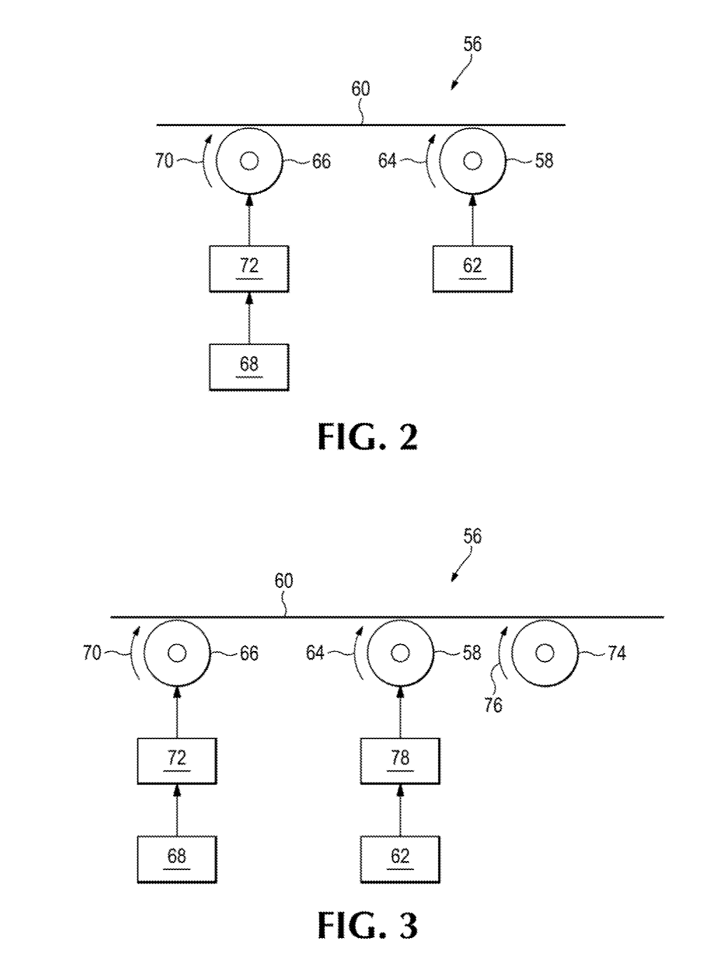

An example of a medium handling apparatus 56 is shown in FIG. 2. Medium handling apparatus 56 may be used in printing device 10 of FIG. 1, as well as other printing devices (not shown). As can be seen in FIG. 2, medium handling apparatus 56 includes a first transport roller 58 to covey a medium 60 and a first drive mechanism 62 to rotate first transport roller 58 at a first rate, as indicated by arrow 64. Medium handling apparatus 56 also includes a second transport roller 66 to convey medium 60 and a second drive mechanism to rotate second transport roller 66 at a second rate, as indicated by arrow 70. Although respective first and second transport rollers 58 and 66 are represented by a single roller in FIG. 2, it is to be understood that either or both of them may include multiple rollers, as well as other components.

As can also be seen in FIG. 2, medium handing apparatus 56 additionally includes a coupling assembly 72 to disengage second transport roller 66 from second drive mechanism 68 to allow medium 60 to rotate second transport roller 66 at first rate 64. This disengagement provided for by coupling assembly 72 of medium handling apparatus 56 allows respective first and second transport rollers 58 and 66 to rotate at substantially the same rate 64 so that tension in medium 60 is properly controlled. As discussed above, this proper control of tension helps both to ensure accurate advancement of medium 60 and to limit lateral movement of medium 60. Medium handling apparatus 56 also provides a relatively simple, cost-effective, efficient, and compact media tension control solution compared to other possible media tension control solutions, as discussed above.

An example of additional components of medium handling apparatus 56 is shown in FIG. 3. As can be seen in FIG. 3, medium handling apparatus 56 may additionally include a drive roller assembly 74 adjacent first transport roller 58. Drive roller assembly 74 conveys medium 60 to a printzone of a printing device, such as printzone 24 of printing device 10, at a third rate, as indicated by arrow 76. Although drive roller assembly is represented by a single roller in FIG. 3, it is to be understood that it may include multiple rollers, as well as other components.

As can also be seen in FIG. 3, medium handling apparatus 56 may further include an additional coupling assembly 78 to disengage first transport roller 58 from first drive mechanism 62 to allow medium 60 to rotate first transport roller at third rate 76. This disengagement provided for by coupling assembly 78 of medium handling apparatus 56 allows respective first and second transport tollers 58 and 66 to rotate at substantially the same rate 76 as drive roller assembly 74 so that tension in medium 60 is properly controlled. As discussed above, this proper control of tension helps both to ensure accurate advancement of medium 60 and to limit lateral movement of medium 60. Medium handling apparatus 56 also provides a relatively simple, cost-effective, efficient, and compact media tension control solution compared to other possible media tension control solutions, as discussed above.

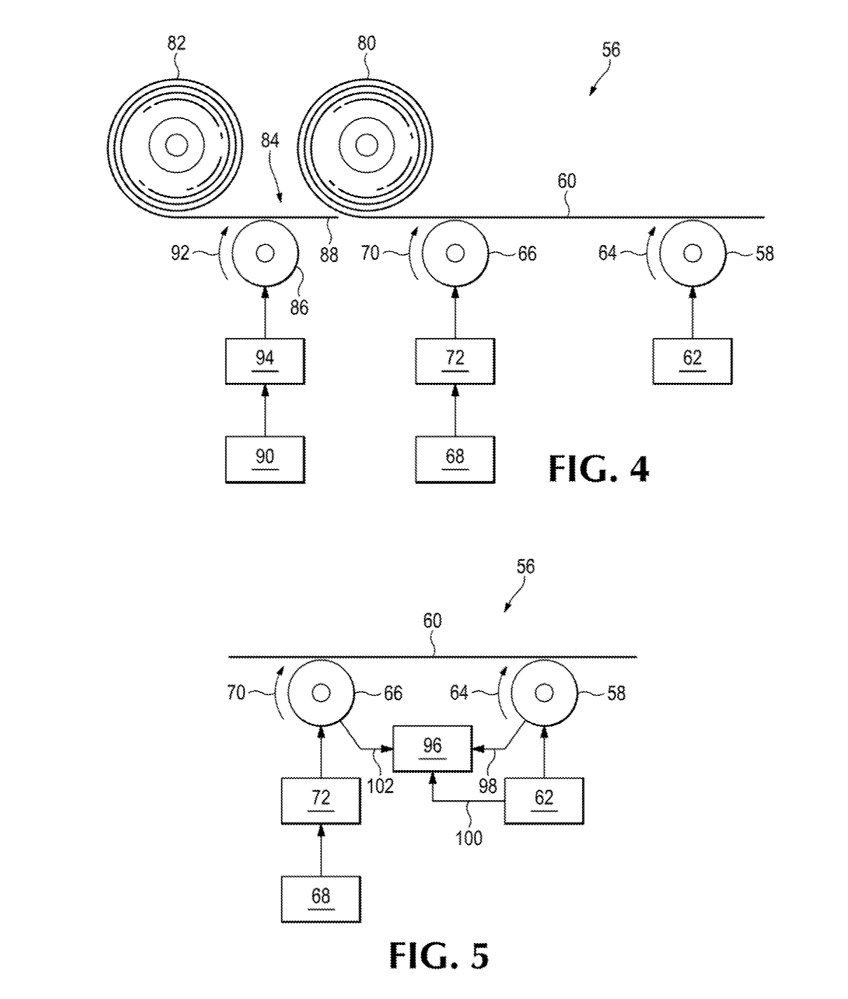

Another example of additional components of medium handling apparatus 56 is shown in FIG. 4. As can be seen in FIG. 4, medium handling apparatus 56 may include may include a plurality of media supplies 80 and 82 (in this example both rolls of media) and a media path 84 to selectively couple one of media supplies 80 and 82 to lust transport roller 58. Media supplies 80 and 82 may be the same type of medium or different types of medium. As can also be seen in FIG. 4, medium handling apparatus 56 includes a third transport roller 86 to convey a selected different medium 88 of media supply 82 to first transport roller 58. Although third transport roller 86 is represented by a single roller in FIG. 4, it is to be understood that it may include multiple rollers, as well as other components.

As can additionally be seen in FIG. 4, this example of medium handing apparatus 56 further includes a third drive mechanism 90 to rotate third transport roller 86 at a third rate 92 and a coupling assembly 94 to disengage third transport roller 88 from third drive mechanism 90 to allow medium 88 to rotate third roller 86 at first rate 64 of first transport roller 58. This disengagement provided for by coupling assembly 94 of medium handling apparatus 56 allows respective first and third transport rollers 58 and 86 to rotate at substantially the same rate 64 so that tension in selected medium 88 is properly controlled. As discussed above, this proper control of tension helps both to ensure accurate advancement of medium 88 and to limit lateral movement of medium 88. This also allows this example of medium handling apparatus 56 to provide a relatively simple, cost-effective, efficient, and compact media tension control solution compared to other possible media tension control solutions, as discussed above.

An additional example of a further component of medium handling apparatus 56 is shown in FIG. 5. As can be seen in FIG. 5, medium handling apparatus 56 may additionally include an encoder assembly 96 coupled to at least one of first transport roller 58, first drive mechanism 62, and second transport roller 66, as indicated by respective arrows 98, 100, and 102. This coupling allows encoder assembly 96 to detect at least one of a breaking of medium 60, and end of medium 60 or a speed of medium 60 by monitoring rates of rotation of first transport roller 58, first drive mechanism 62 and/or second transport roller 66.

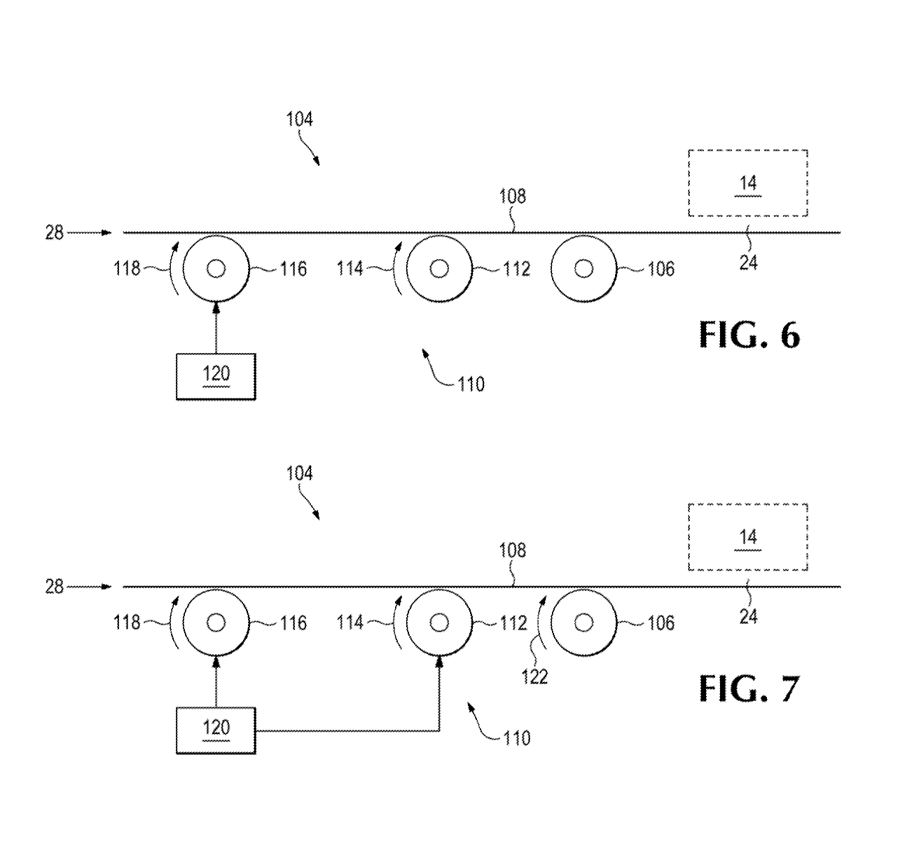

An alternative example of a medium handling apparatus 104 is shown in FIG. 6. Medium handling apparatus 104 may be used in printing device 10 of FIG. 1, as well as other priming devices (not shown). As can be seen in FIG. 6, medium handling apparatus 104 includes a drive roller assembly 106 to covey a medium 108 to printzone 24 of printing device 10. Medium handling apparatus 104 also includes a transport roller assembly 110 that includes a first transport roller 112 adjacent drive roller assembly 106 and rotatable at a first rate, as indicated by arrow 114, to convey medium 108 to drive roller assembly 106. Transport roller assembly 110 also includes a second transport roller 116 adjacent medium input 28 and rotatable at a second rate, as indicated by arrow 118, to convey medium 108 from medium input 28. Although respective first and second transport rollers 112 and 116 of transport roller assembly 110 and drive roller assembly 106 are each represented by a single roller in FIG. 6, it is to be understood that some or all of them may include multiple rollers, as well as other components.

As can also be seen in FIG. 6, medium handling apparatus 104 additionally includes a freewheel assembly 120 to control the second rate of rotation 118 of second transport roller 116 of transport roller assembly 110 based on the first rate of rotation 114 of first transport roller 112 of transport roller assembly 110. This control provided for by freewheel assembly 120 of medium handling apparatus 104 allows respective first and second transport rollers 112 and 116 to rotate at substantially the same rate 114 so that tension in medium 108 is properly controlled. As discussed above, this proper control of tension helps both to ensure accurate advancement of medium 108 and to limit lateral movement of medium 108. Medium handling apparatus 104 also provides a relatively simple, cost-effective, efficient, and compact media tension control solution compared to other possible media tension control solutions, as discussed above.

An example of additional components of medium handling apparatus 104 is shown in FIG. 7. As can be seen in FIG. 7, drive roller assembly 106 conveys medium 108 to printzone 24 of priming device 10 at a third rate, as indicated by arrow 122 and freewheel assembly 120 of medium handling apparatus 104 controls the rate of rotation of first transport roller 112 based on third rate of rotation 122 of drive roller assembly 106. This control provided for by freewheel assembly 120 of medium handling apparatus 104 allows respective first and second transport rollers 112 and 116 of transport roller assembly 110 to rotate at substantially the same rate 122 as drive roller assembly 106 so that tension in medium 108 is properly controlled. As discussed above, this proper control of tension helps both to ensure accurate advancement of medium 108 and to limit lateral movement of medium 108. Medium handling apparatus 104 also provides a relatively simple, cost-effective, efficient, and compact media tension control solution compared to other possible media tension control solutions, as discussed above.

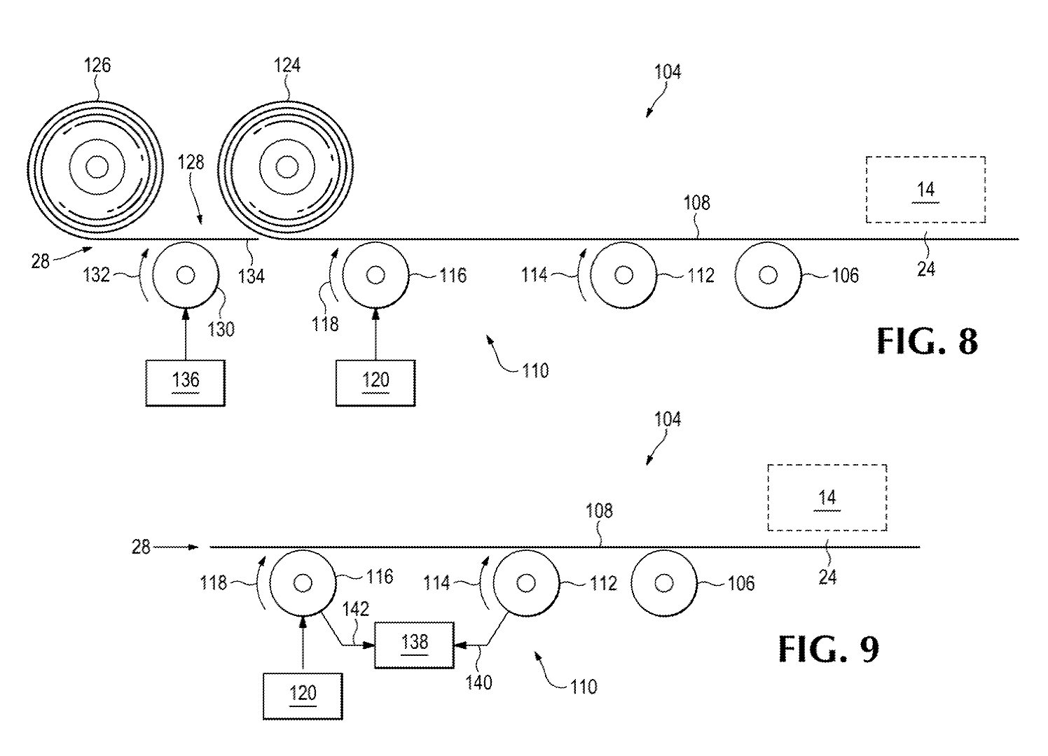

Another example of additional components of medium handling apparatus 104 is shown in FIG. 8. As can be seen in FIG. 8, medium handling apparatus 104 may include may include a plurality of media supplies 124 and 126 (in this example both rolls of media) and a media path 128 to selectively couple one of media supplies 124 and 126 to first transport roller 112 of transport roller assembly 110. Media supplies 124and 126 may be the same type of medium or different types of medium. As can also be seen in FIG. 8, transport roller assembly 110 of medium handling apparatus 104 includes a third transport roller 130 rotatable at a fourth rate, as indicated by arrow 132, to convey a selected different medium 134 of media supply 126 to first transport roller 112. Although third transport roller 130 is represented by a single roller in FIG. 8, it is to be understood that it may include multiple rollers, as well as other components.

As can additionally be seen in FIG. 8, this example of medium handing apparatus 104 further includes a freewheel assembly 136 to control the fourth rate of rotation 132. This control provided for by freewheel assembly 136 of medium handling apparatus 104 allows respective first and third transport rollers 112 and 130 to rotate at substantially the same rate 114 so that tension in selected medium 134 is properly controlled. As discussed above, this proper control of tension helps both to ensure accurate advancement of medium 134 and to limit lateral movement of medium 134. This also allows this example of medium handling apparatus 104 to provide a relatively simple, cost-effective, efficient, and compact media tension control solution compared to other possible media tension control solutions, as discussed above.

An additional example of a further component of medium handling apparatus 104 is shown in FIG. 9. As can be seen in FIG. 9, medium handling apparatus 104 may additionally include an encoder assembly 138 coupled to at least one of first transport roller 112 and second transport roller 116, as indicated by respective arrows 140 and 142. This coupling allows encoder assembly 138 to detect at least one of a breaking of medium 108, and end of medium 108 or a speed of medium 108 by monitoring rates of rotation of first transport roller 112 and/or second transport roller 116.

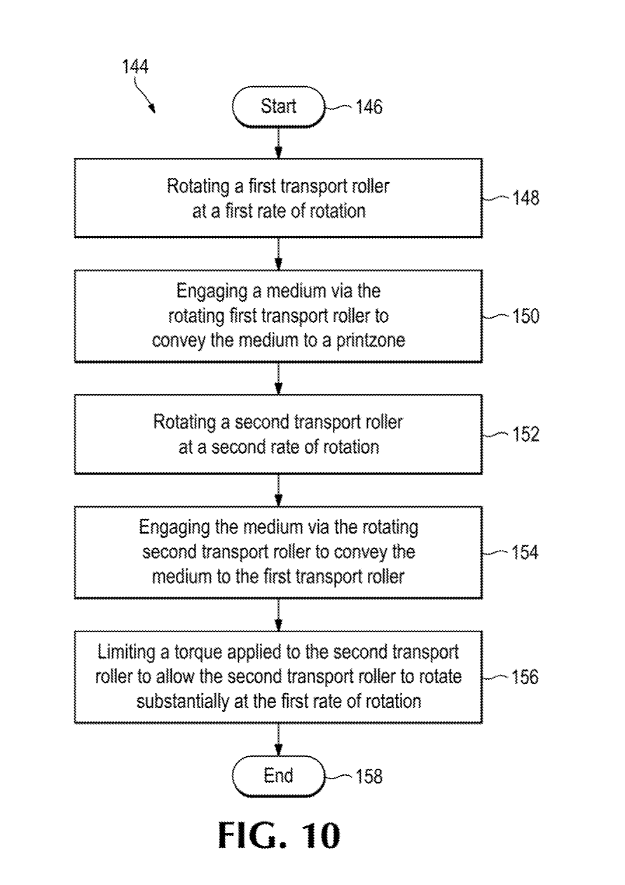

An example of a medium handling method 144 for use in printing device 10 is shown in FIG. 10. As can be seen in FIG. 10, medium handling method 144 starts 146 by rotating a first transport roller at a first rate of rotation, as indicated by block 148, and engaging a medium via the rotating first transport roller to convey the medium to a printzone of the printing device, as indicated by block 150. Medium handling method 144 continues by rotating a second transport roller at a second rate of rotation, as indicated by block 152, and engaging the medium via the rotating second transport roller to convey the medium to the first transport roller, as indicated by block 154. Medium handling method 144 further continues by limiting a torque applied to the second transport roller to allow the second transport roller to rotate substantially at the first rate of rotation, as indicated by block 156. It should be noted that, in at least some instances, the torque applied to the second transport roller may be limited when the first rate of rotation of the first transport roller is greater than the second rate of rotation of the second transport roller. Medium handling method 144 then ends 158.

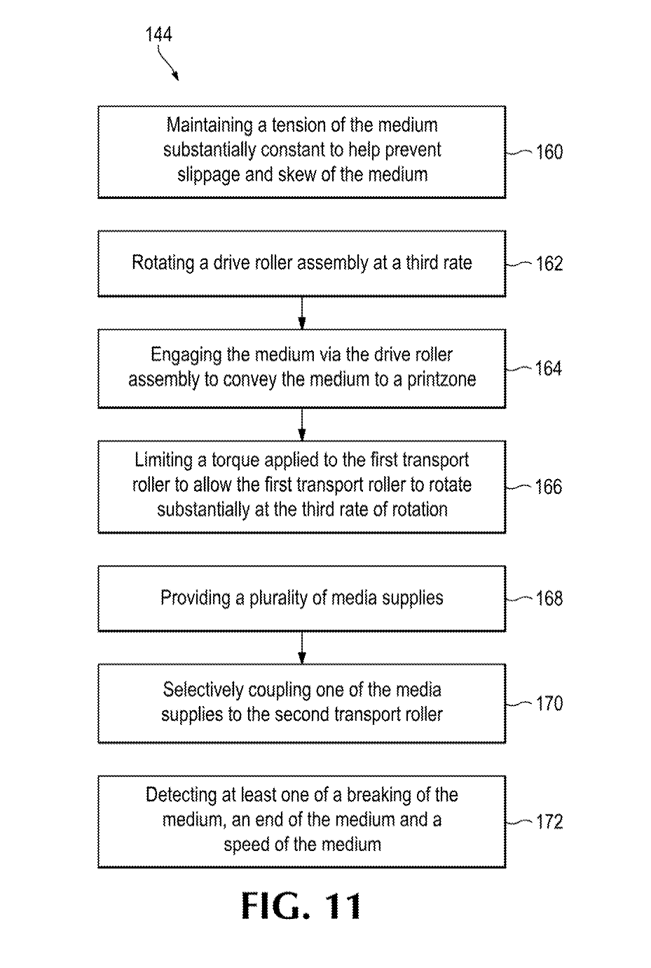

An example of additional elements of media handling method 144 is shown in FIG. 11. As can be seen in FIG. 11, medium handling method 144 may also include maintaining a tension of the medium substantially constant to help prevent slippage and skew of the medium, as indicated by block 160. Alternatively or additionally, medium handling method 144 may additionally include rotating a drive roller assembly at a third rate, as indicated by block 162, engaging the medium via the drive roller assembly to convey the medium to the printzone, as indicated by block 164, and limiting a torque applied to the first transport roller to allow the first transport roller to rotate substantially at the third rate of rotation, as indicated by block 166.

As can also be seen in FIG. 11, medium handling method 144 may alternatively or additionally include providing a plurality of media supplies, as indicated by block 168, and selectively coupling one of the media supplies to the second transport roller, as indicated by block 170. As can additionally be seen in FIG. 11, medium handling method 144 may alternatively or further include detecting at least one of a breaking of the medium, an end of the medium and a speed of the medium, as indicated by block 172.

Although several drawings have been described and illustrated in detail, it is to be understood that the same are intended by way of illustration and example. These examples are not intended to be exhaustive or to be limited to the precise form disclosed. Modifications and variations may well be apparent. For example, medium handling method 144 may be used in printing devices other than printing device 10.

Additionally, reference to an element in the singular is not intended to mean one, unless explicitly so stated, but rather means at least one. Furthermore, unless specifically stated, any method elements are not limited to the sequence or order described and illustrated. Moreover, no element or component is intended to be dedicated to the public regardless of whether the element or component is explicitly recited in the following claims.

What is claimed is:

1. A medium bundling apparatus for use in a priming device, comprising:
a first transport roller to convey a medium;
a first drive mechanism to rotate the first transport roller at a first rate;
a second transport roller to convey the medium;
a second drive mechanism to rotate the second transport roller at a second rate; and
a coupling assembly to disengage the second transport roller from the second drive mechanism to allow the medium to rotate the second transport roller at the first rate.

2. The medium handling apparatus of claim 1, further comprising a drive roller assembly adjacent the first transport roller to convey the medium to a printzone of the printing device at a third rate.

3. The medium handling apparatus of claim 2, further comprising an additional coupling assembly to disengage the first transport roller from the first drive mechanism to allow the medium to rotate the first transport roller at the third rate.

4. The medium handling apparatus of claim 1, further comprising:
a plurality of media supplies; and
a media path to selectively couple one of the media supplies to the second transport roller.

5. The media handling apparatus of claim 1, further comprising an encoder assembly coupled to at least one of the first transport roller, the first drive mechanism, and the second transport roller to detect at least one of a breaking of the medium, an end of the medium and a speed of the medium.

6. A medium handling apparatus for use in a printing device, comprising:
a drive roller assembly to convey a medium to a printzone of the printing device;
a transport roller assembly including a first transport roller adjacent the drive roller assembly and rotatable at a first rate to convey the medium to the drive roller assembly and a second transport roller adjacent a medium input and rotatable at a second rate to convey the medium from the medium input; and
a freewheel assembly to control the second rate of rotation of the second transport roller based on the first rate of rotation of the first transport roller.

7. The medium handling apparatus of claim 6, wherein the drive roller assembly conveys the medium to the printzone of the printing device at a third rate and further wherein the freewheel assembly controls the rate of rotation of the first transport roller based on the third rate of rotation of the drive roller assembly.

8. The medium handling apparatus of claim 6, further comprising:
a plurality of media supplies; and
a media path to selectively couple one of the media supplies to the transport roller assembly.

9. The media handling apparatus of claim 6, further comprising an encoder assembly coupled to at least one of the first transport roller and the second transport roller to detect at least one of a breaking of the medium, an end of the medium and a speed of the medium

10. A medium handling method for use in a printing device, comprising:
rotating a first transport roller at a first rate of rotation;
engaging a medium via the rotating lust transport roller to convey the medium to a printzone of the printing device;
rotating a second transport roller at a second rate of rotation;
engaging the medium via the rotating second transport roller to convey the medium to the first transport roller; and
limiting a torque applied to the second transport roller to allow the second transport roller to rotate substantially at the first rate of rotation.

11. The medium handling method of claim 10, wherein the torque applied to the second transport roller is limited when the first rate of rotation of the first transport roller is greater than the second rate of rotation of the second transport roller.

12. The medium handling method of claim 10, further comprising maintaining a tension of the medium substantially constant to help prevent slippage and skew of the medium.

13. The medium handling method of claim 10, further comprising; rotating a drive roller assembly at a third rate;
engaging the medium via the drive roller assembly to convey the medium to the printzone; and
limiting a torque applied to the first transport roller to allow the first transport roller to rotate substantially at the third rate of rotation.

14. The medium handling method of claim 10, further comprising;
providing a plurality of media supplies; and
selectively coupling one of the media supplies to the second transport roller.

15. The medium handling method of claim 10, further comprising detecting at least one of a breaking of the medium, an end of the medium and a speed of the medium.
